(19) United States
(12) Patent Application Publication
(10) Pub. No.: US 2007/0250647 A1
(43) Pub. Date: Oct. 25, 2007

(54) COMMUNICATION TERMINAL USING ETHERNET INTERFACE

(76) Inventors: Kwang Chul Jeon, San Diego, CA (US); Gwan-Hee You, San Diego, CA (US); Henry Kim, San Diego, CA (US)

Correspondence Address: DUANE MORRIS, LLP;IP DEPARTMENT, 30 SOUTH 17TH STREET, PHILADELPHIA, PA, 19103-4196, US

(21) Appl. No.: 11/670,808

(22) Filed: Feb. 2, 2007

Related U.S. Application Data
(60) Provisional application No. 60/745,211, filed on Apr. 20, 2006.
(60) Provisional application No. 60/746,337, filed on May 3, 2006.

(51) Int. Cl. G06F 15/16

(52) U.S. Cl. 709/250; 709/253; 714/712; 370/242

(57) ABSTRACT

A system and method for controlling and monitoring a wireless communication device. Communication between a communication manager and a wireless communication device is via Ethernet data, and communication between an Ethernet interface controller and a wireless communication module, both in the wireless communication device is via USB data.

### RELATED APPLICATIONS

This application claims the benefits of priority of U.S. Provisional Patent Application Ser. No. 60/745,211, filed Apr. 20, 2006, and U.S. Provisional Patent Application Ser. No. 60/746,337, filed May 3, 2006, both entitled “Communication Management for CDMA/GSM Device Using Ethernet Interface”. This application is also related to U.S. patent application Ser. No. 11/206,961 and U.S. patent application Ser. No. 11/206,962. The disclosures of all of these applications are hereby incorporated by reference, in their entirety.

### BACKGROUND

1. Field of the Invention

This invention relates to wireless communication devices, and more particularly to a wireless communication device using an Ethernet interface to an external device.

2. Background

When communicating between a wireless, or cellular, communication device, such as a Code Division Multiple Access (CDMA) or Global Standard for Mobile Communications (GSM) device, and a computing device, such as a computer, a Universal Asynchronous Receive/Transmitter (UART) controller or Universal Serial Bus (USB) controller is often used. However, to use the UART controller, an appropriate cable is required for connecting the wireless communication device to the UART controller. To use the USB controller, the computing device needs to load and install device driver software compatible with the operating system of the computing device. Use of a special cable or software to communicate with the wireless communication device can be inconvenient.

### SUMMARY

Implementations of the present invention include techniques for managing and controlling a wireless communication device.

In one implementation, a method for managing a wireless communication device comprises; receiving Ethernet data from an external device at an Ethernet interface of the wireless communication device, wherein the data includes network data and diagnostic data; assigning a first USE channel to the network data and a second USB channel to the diagnostic data; communicating the first and second USB channels to a wireless communication module; receiving two channels of USB data from the wireless communication module, wherein USB data assigned to a first channel is network data and data assigned to a second channel is diagnostic data; and communicating the network data and diagnostic data to the Ethernet interface as Ethernet data.

In another implementation, a wireless communication device comprises: an Ethernet port configured to transmit and receive Ethernet data with external devices; an Ethernet interface controller module in communication with the Ethernet port; and a wireless communication module in communication with the Ethernet interface controller module and in communication with a wireless network, wherein communication between the Ethernet interface controller and the Ethernet port comprises Ethernet communication that includes management data and network data, wherein communication between the Ethernet interface controller module and the wireless communication module comprises USB communication, and wherein the management data is assigned to a first USB channel and the network data is assigned to a second USE channel.

Other features and advantages of the present invention should be apparent from the following description which illustrates, by way of example, aspects of the invention.

### BRIEF DESCRIPTION OF THE DRAWINGS

FIG. 1 is a block diagram of an example system in accordance with aspects of the invention.

FIG. 2 is a block diagram illustrating further details of an implementation of the computing device and wireless communication device of FIG. 1.

FIG. 3 is a block diagram illustrating further detail of an implementation of the Ethernet interface controller.

FIG. 4 is a block diagram illustrating another implementation of the Ethernet interface controller.

FIG. 5 is an example flow diagram of an initialization routine for the Ethernet interface controller.

FIG. 6 is a flowchart illustrating an example of the Ethernet interface controller idle routine.

FIG. 7 is an example flow diagram of an Ethernet interface controller diagnostic data manager routine.

FIG. 8 is an example flow diagram of a Ethernet interface controller traffic idle routine.

FIG. 9 is an example flow diagram of a wireless communication module initialization routine.

FIG. 10 is an example flow diagram of a wireless communication idle routine.

FIG. 11 is an example flow diagram of a wireless communication module diagnostic data manager.

FIG. 12 is an example flow diagram of a wireless communication module traffic idle routine.

FIG. 13 is an example flow diagram of a communication manager for the wireless communication device.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

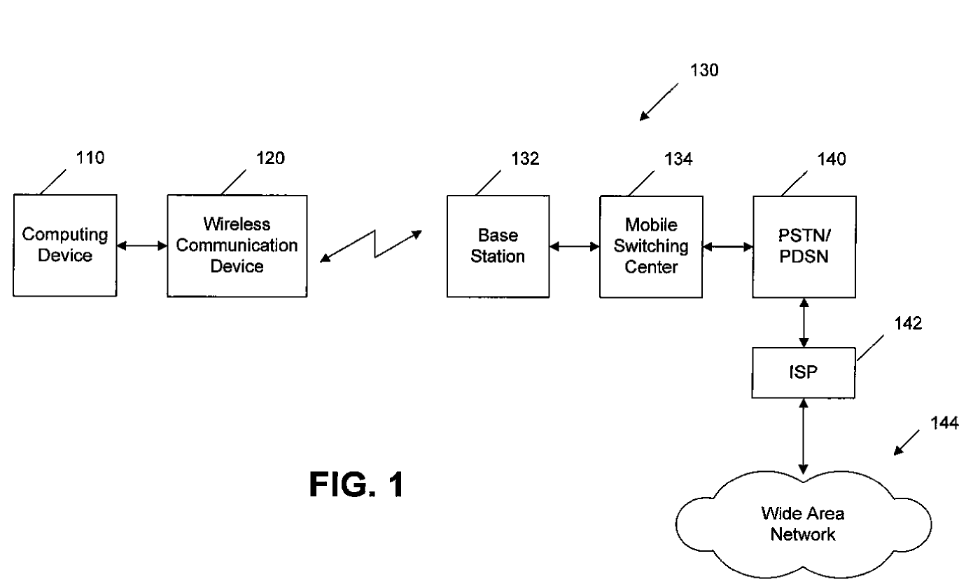

FIG. 1 is a block diagram of an example system in accordance with aspects of the invention. As shown in FIG. 1, a computing device 110 is in communication with a wireless, or cellular, communication terminal, or device 120. In one implementation, the computing device 110 communicates with the wireless communication device 120 using an Ethernet connection. Using an Ethernet connection is desirable because an Ethernet connection does not require installation of any additional drivers not already residing on the computing device 120 and can support existing routed networks.

The wireless communication device 120 is in communication with a wireless infrastructure 130. In one embodiment, the wireless infrastructure includes a base station 132 that receives and transmits voice and data traffic to the wireless communication device 120. The wireless infrastructure also includes a mobile switching center 134 that interfaces to a serving node 140. In one embodiment, the serving node 140 is configured as a public switched telephone network (PSTN). In another embodiment, the serving node 140 is configured as a packet data serving node (PDSN). An internet service provider 142 can provide access to the Internet or other wide area network 144. In this way, the computing device 110 can use the wireless communication device 120 to access the Internet 144.

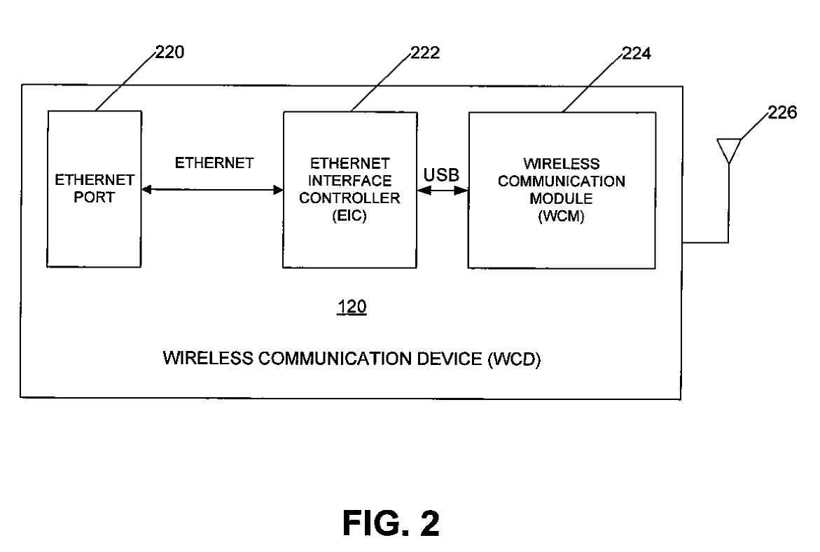

FIG. 2 is a block diagram illustrating further details of an implementation of the wireless, or cellular, communication device (WCD) 120. The wireless communication device 120 is also referred to as a communication terminal. In one example, the communication terminal includes wireless broadband modem and gateway with Wi-Fi router.

As shown in the example of FIG. 2, the wireless communication device 120 includes an Ethernet port 220, an Ethernet interface controller (EIC) 222, a wireless, or cellular, communication module (WCM) 224, and an antenna 226. In one implementation, the wireless communication device 120 is configured to receive management and diagnostic tasks from an external computing device (not shown) via the Ethernet port 220. For example, an external computing device may request the performance of tasks by the wireless communication device 120, such as, accessing system status data, accessing security control features, configuring and modifying service parameters, upgrading system software, performing system tests, collecting system information, downloading and/or debugging system software/firmware, accessing performance status data, and other related tasks.

In one example, status of components within the wireless communication device 120 can be provided to an external device via the Ethernet port 220. In addition, the wireless communication device 120 can download software updates and/or patches from the Internet for updating the software and/or firmware operating on the wireless communication device 120. The download can be in response to a request or command from an external device, or can be initiated by the wireless communication device 120 itself. For example, the wireless communication device 120 can be configured to periodically query a web site to determine if there is a software update, or patch, available for software or firmware operating in the wireless communication device 120, and the update or patch can be downloaded and installed. In another embodiment, the IP address of the wireless communication device 120 may be known to a web site that pushes an update of patch to the wireless communication device 120 when appropriate.

As shown in FIG. 2, data communicated between the wireless communication device 120 and an external device is via an Ethernet connection, and data communicated between the EIC 222 and the WCM 224, within the wireless communication device 120, is via a USB connection. The EIC 222 receives Ethernet data from the Ethernet port 220, formats the data, and outputs it as USB data to the WCM 224. Likewise, the EIC 222 receives USB data from the WCM 224, formats the data, and outputs it as Ethernet data to the Ethernet port 220. An advantage to this configuration is that many external devices have an Ethernet connection as a standard network interface, and many WCMs 224 have a USB port as a standard interface.

Using the Ethernet connection between the wireless communication device 120 and an external device, such as a computer, the external device can receive services at or provide services to the wireless communication device 120. Types of services include the Internet service and/or other monitoring functions. For example, providing the monitoring functions for the wireless communication device 120 includes monitoring the status, changing operating parameters, running diagnostics, and otherwise providing functions related to status and management of the wireless communication device 120.

Advantages of using the Ethernet connection for communication between the wireless communication device and an external device include: (1) absence of the need to provide a special cable appropriate for connecting the wireless communication device 120 to a UART controller in an external device; (2) absence of the need to provide a USB device driver software compatible with an operating system in the external device; and (3) the ability to monitor/change the status and operation of the wireless communication device while simultaneously using the Internet connection of the wireless communication device.

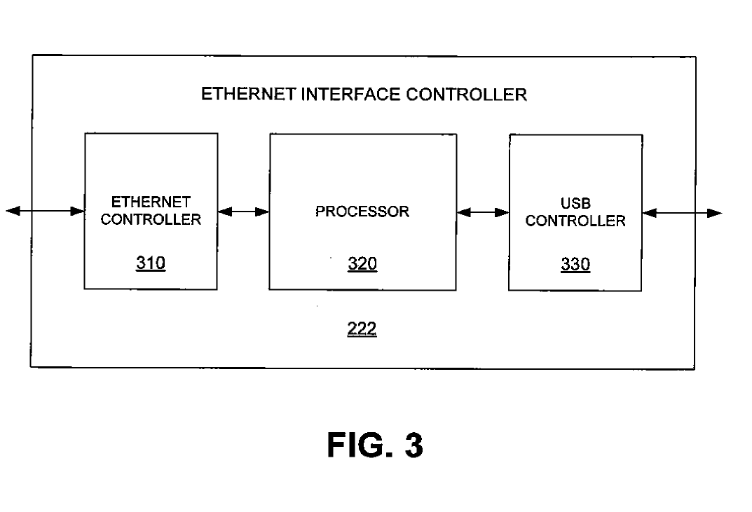

FIG. 3 is a block diagram illustrating further detail of an example implementation of the Ethernet interface controller (EIC) 222. As shown in the example of FIG. 3, the EIC 222 includes an Ethernet controller 310, a processor 320 and a universal serial bus (USB) controller 330. The processor 320 may include a central processing unit, as well as memory and peripheral controllers.

In one implementation, the Ethernet controller 310 receives Ethernet data from an external device, such as a computing device. The Ethernet controller 310 decodes and communicates the data to the processor 320. The processor 320 analyzes the data to determine if it is a request or command for status or management data of the wireless communication device, or if it is data for a wide area network, such as the Internet. The processor 320 then formats the data and communicates it to the USB controller 330 where it is output to the WCM 224 (see FIG. 2). Likewise the USB controller 330 can receive USB data from the WCM 224, decode it, and communicate the data to the processor 320. The processor 320 analyzes the data to determine if it is status and management data of the wireless communication device 120 or data from a wide area network, such as the Internet. The processor 320 then formats the data and communicates it to the Ethernet controller 310 where it is output to an external device.

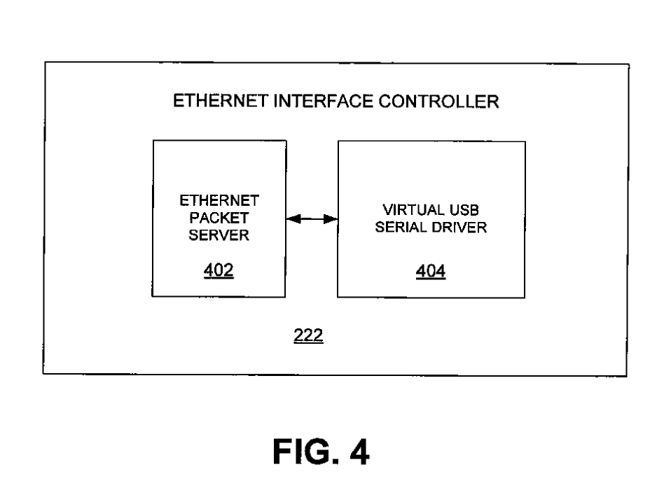

FIG. 4 is a block diagram illustrating another example implementation of the Ethernet interface controller (EIC) 222. As shown in FIG. 4, the EIC 222 includes an Ethernet packet server 402 and a virtual USB serial driver 404. The Ethernet packet server 402 provides management of the connection between the EIC 222 and an external device, such as a computing device, using TCP/IP. The Ethernet packet server 402 also supports diagnostic monitoring protocol for status monitoring and status conversion. The diagnostic protocol enables an external device, such as a computing device, to monitor and manage the current status of the EIC 222 and a wireless communication module 224.

The virtual USB serial driver 404 provides an interface between the EIC 222 and the wireless communication module 224. The virtual serial driver 404 can be configured with one USB line, or channel, to provide service, status monitoring, status conversion, diagnostic monitoring, and another USB line for Network data, such as Internet communication.

While the examples described for the Ethernet interface controller 222 included a number of separate modules, the functions performed by the modules can be combined into a single module or any desired number of modules.

Communicating status and management data, as well as network data, such as Internet data, can use a technique referred to as two channel protocol. In one implementation of a two channel protocol, using USB communication between the USB controller 330 and the WCM 224, the EIC 222 is able to simultaneously transmit and receive Internet and diagnostic data. To be able to receive and transmit the two types of information at the USB port of the USB controller 330, the information can be classified into different protocol channels. For example, one USB address, or channel, can be assigned to the Internet data, and a different USB address can be assigned to the diagnostic data. In this way one type of data can be distinguished from the other data. Of course, as many channels as desired can be used for classifying the data, up to the number of USB addresses available.

Following are several examples of providing a data interface with the Internet, and a data interface for status monitoring and selection.

In a first implementation of FIG. 2, devices and modules that provide a data interface with the Internet are configured as follows:

(1) Data flow from the Internet to a computing device can occur as follows: the wireless communication device 120 receives data from the Internet through the antenna 226; the Internet data flows from the antenna 226 to the wireless communication module 224 and then to the Ethernet interface controller 222; and the Ethernet interface controller 222 directs/transmits the Internet data to the Ethernet port 220 where it is available to external devices.

(2) Data flow from an external device to the Internet can occur as follows: the external device directs/transmits data for the Internet to the Ethernet interface controller 222 through the Ethernet port 220; the data for the Internet flows from the Ethernet interface controller 222 to the wireless communication module 224, and then to the antenna 226; and the wireless communication device 120 transmits the data to the Internet through the antenna 226.

In a second implementation of FIG. 2, devices and modules that provide a data interface with the Ethernet interface controller 222 for status monitoring and selection are configured as follows:

(1) Data flow from the Ethernet interface controller 222 to an external device for status monitoring is as follows: data is delivered from the Ethernet interface controller 222 to the Ethernet port; the data is then available to external devices via the Ethernet port.

(2) Data flow from an external device to the Ethernet interface controller 222 for status selection/conversion is as follows: data is routed from the external device to the Ethernet port 220; and the data is then delivered from the Ethernet port 220 to the Ethernet interface controller 222.

In a third implementation of FIG. 2, devices and modules that provide a data interface with the wireless communication module 224 for status monitoring and selection are configured as follows:

(1) Data flow from the wireless communication module 224 to an external device for status monitoring is as follows: data is delivered from the wireless communication module 224 to the Ethernet interface controller 222; the Ethernet interface controller 222 delivers the received data to the Ethernet port 220; the data is then routed to an external device through an Ethernet connection.

(2) Data flow from an external device to the wireless communication module 224 for status selection/conversion is as follows: data is routed from the Ethernet port 220; the data is delivered from Ethernet port 220 to the Ethernet interface controller 222; and the data is then routed from the Ethernet interface controller 222 to the wireless communication module 224.

As shown in the implementations of FIG. 2, the modules can be configured to provide data interface with the Internet while simultaneously providing status monitoring and parameter selection of the Ethernet interface controller 222 and the wireless communication module 224. Thus, the steps listed under the second and third implementations can be executed simultaneously while the steps under the first implementation are being executed to provide data interface with the Internet.

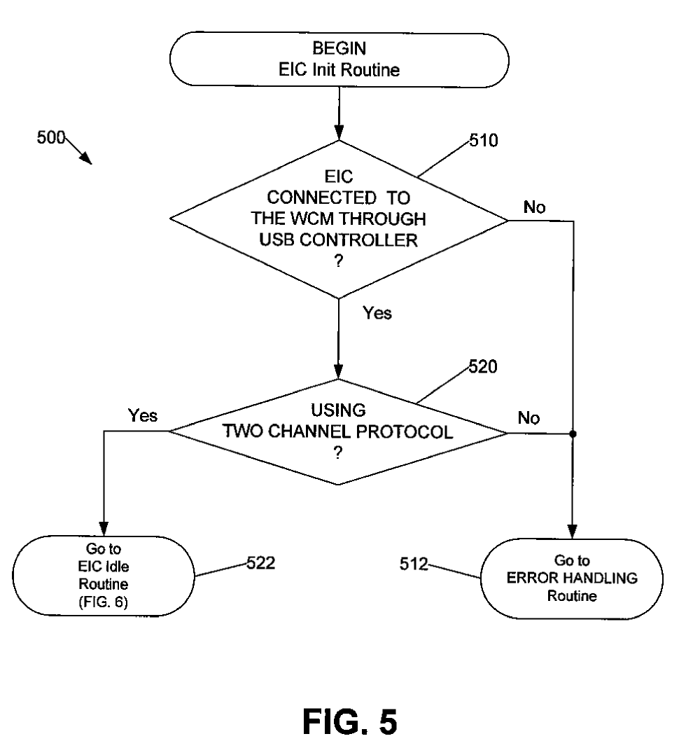

FIG. 5 is a flow diagram of an example initialization routine 500 for the Ethernet interface controller 222. The routine 500 determines if the Ethernet interface controller 222 is connected to the wireless communication module 224 through the USB controller, at block 510. If the Ethernet interface controller 222 is not connected to the wireless communication module 224, then the routine 500 continues to an error-handling routine of block 512. Otherwise, if the Ethernet interface controller 222 is connected to the wireless communication module 224 through the USB controller, then the routine 500 continues onto block 520. At block 520, it is determined if the Ethernet interface controller 222 is using a two-channel protocol. If the Ethernet interface controller 222 is not using a two-channel protocol, then the routine 500 proceeds to an error-handling routine of block 512. If the controller is using a two-channel protocol, then the routine 500 continues to an Ethernet interface controller (EIC) idle routine 600, at block 522.

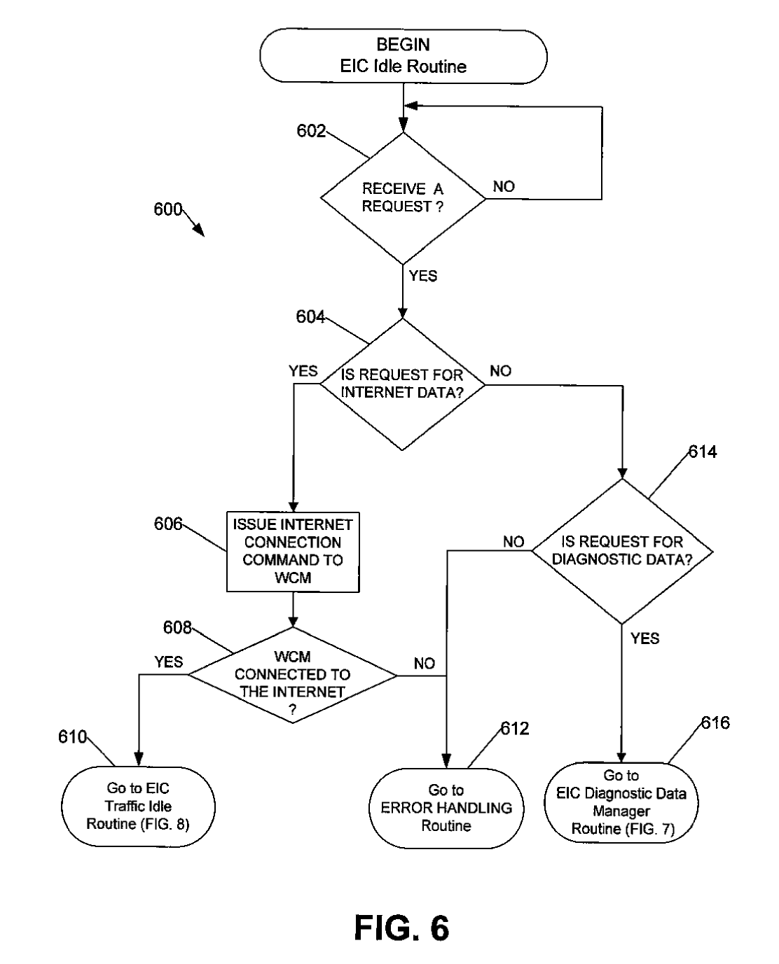

FIG. 6 is a flowchart illustrating an example of the EIC idle routine 600. In block 602, the Ethernet interface controller 222 determines if it has received a request. If a request has not been received, the routine 600 remains in block 602 waiting for a request.

When a request is received, the routine 600 continues to block 604 where it is determined if the request is for Internet data. If the request is for the Internet data, then the Ethernet interface controller 222 issues, at block 606, an Internet connection command to a wireless communication module 224. Then, at block 608, it is determined if the wireless communication module 224 successfully connected to the Internet. If the wireless communication module 224 successfully connected to the Internet, then the routine 600 continues to an EIC traffic idle routine 800, at block 610. Returning to block 608, if the wireless communication module 224 did not successfully connect to the Internet, the routine 600 continues to the error handling routine, at block 612.

Returning to block 604, if the request is not for the Internet data, then it is determined, at block 614, if the request is for diagnostic data. If the request is for the diagnostic data, then the routine 600 continues to an EIC diagnostic data manager routine 700, at block 616. If the request is not for the diagnostic data, then the routine 600 continues to the error handling routine, at block 612.

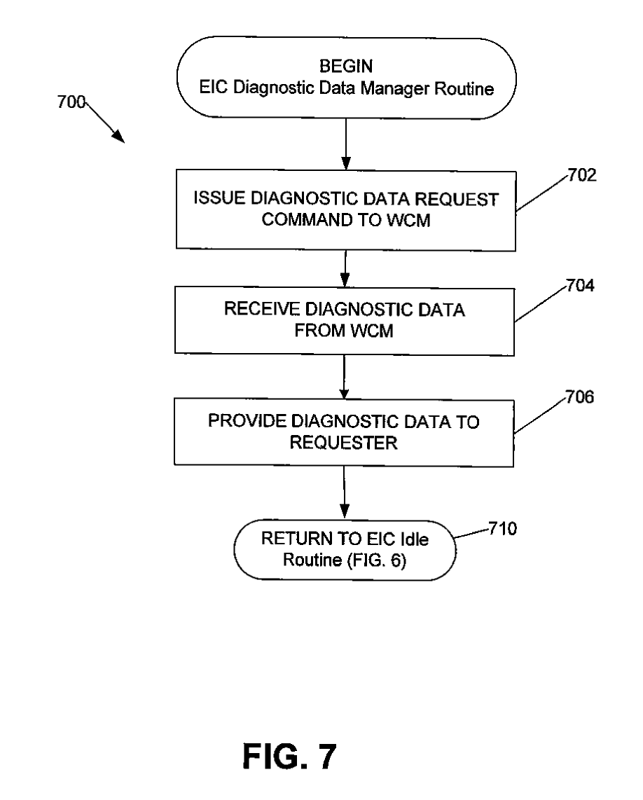

FIG. 7 is an example flow diagram of the EIC diagnostic data manager routine 700. In block 702, the Ethernet interface controller 222 issues a diagnostic data request command to the wireless communication module. Then, at block 704, the Ethernet interface controller 222 receives diagnostic data from the wireless communication module 224. At block 706, the Ethernet interface controller 222 provides the diagnostic data to the requester. The routine 700 then continues, and returns to the EIC idle routine 600, at block 710.

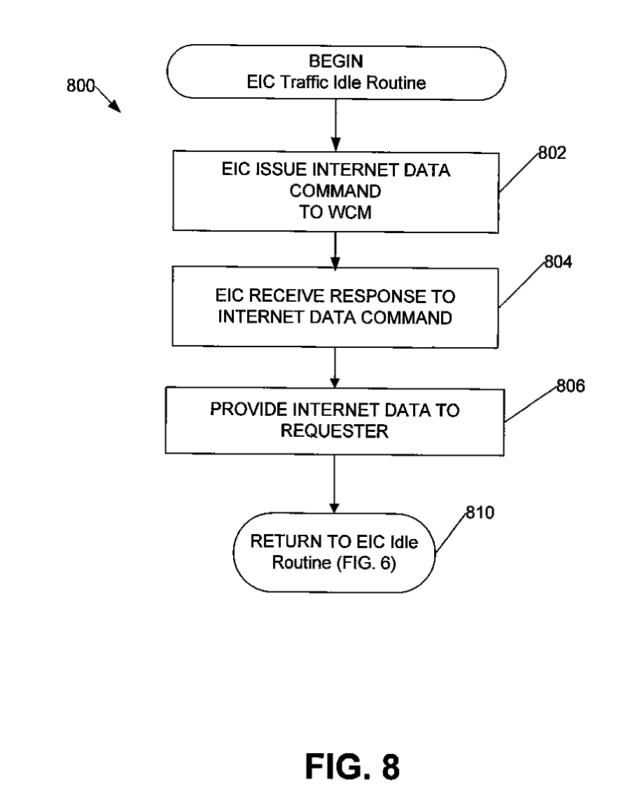

FIG. 8 is an example flow diagram of the EIC traffic idle routine 800. At block 802, the Ethernet interface controller 222 issues an Internet data command to the wireless communication module 224. Then, the Ethernet interface controller 222 receives a response to the Internet data command from the wireless communication module 224, at block 804. At block 806, the Internet data is provided to the requester. The routine 800 then continues to block 810 and returns to the EIC idle routine 600.

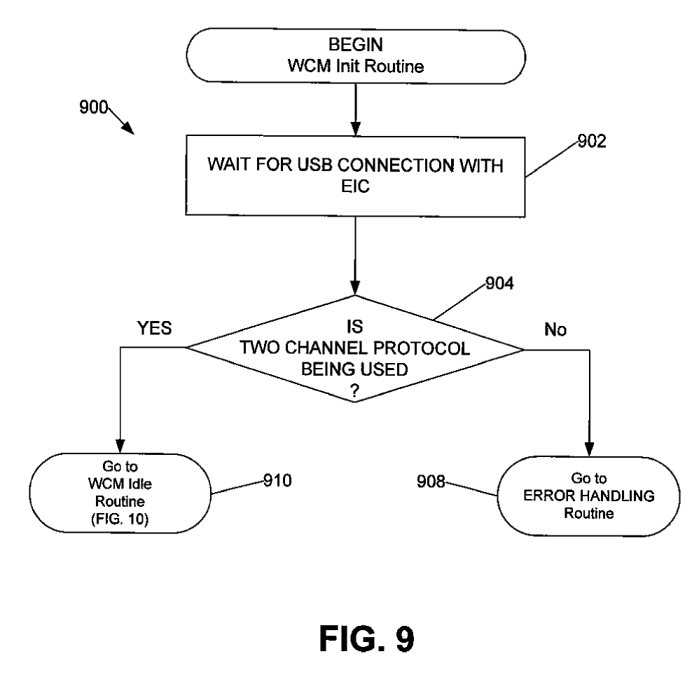

FIG. 9 is an example flow diagram of a wireless communication module (WCM) initialization routine 900. In block 902, the wireless communication module 224 waits for a USB connection with the Ethernet interface controller 222. After the USB connection has been established, it is determined, at block 904, if a two-channel protocol is being used. If a two-channel protocol is not being used, then the routine 900 continues to an error handling routine, at block 908. If a two-channel protocol is being used, then the routine 900 continues to a WCM idle routine 1000, at block 910.

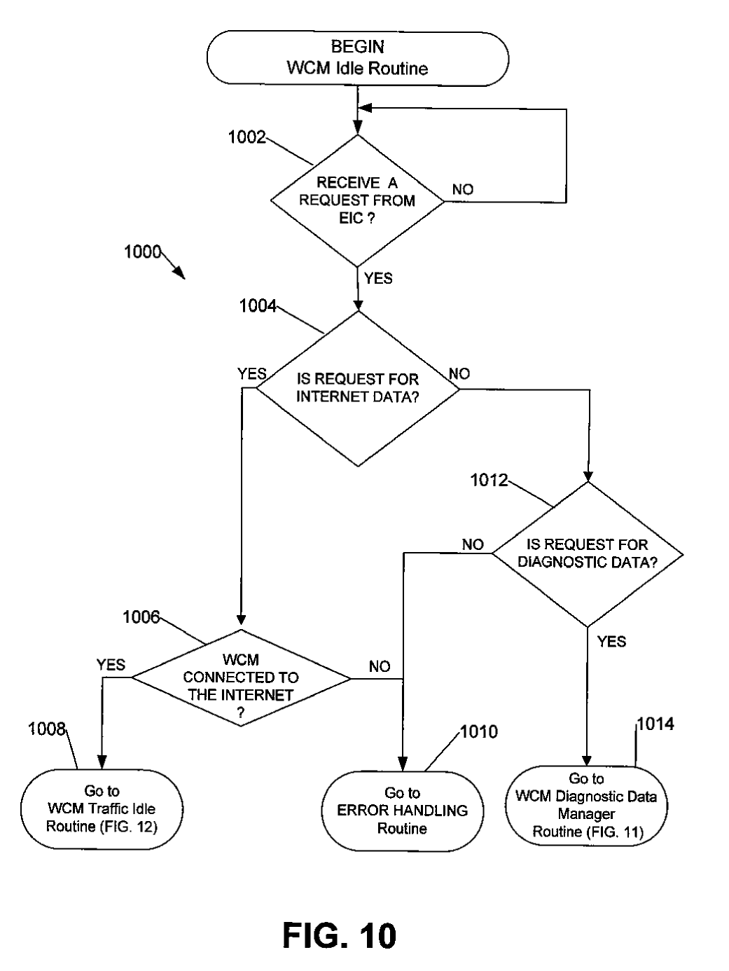

FIG. 10 is an example flow diagram of the WCM idle routine 1000. In block 1002, the wireless communication module 224 determines if it has received a request from the Ethernet interface controller 222. If the wireless communication module 224 has not received a request, the routine 1000 remains in block 1002. When a request is received, the routine 1000 continues to block 1004 where it is determined if the request is for Internet data. If the request is for the Internet data, then the wireless communication module 224 attempts to connect to the Internet, at block 1006. If the wireless communication module 224 is already connected to the Internet or can successful connect to the Internet, then the routine 1000 continues to a WCM traffic idle routine 1200, at block 1008. If the wireless communication module 224 is not successful in connecting to the Internet, the routine 1000 continues to an error handling routine, at block 1010.

Returning to block 1004, if the request is not for the Internet data, the routine 1000 continues to block 1012. At block 1012, it is determined if the request is for diagnostic data. If the request is for the diagnostic data, the routine 1000 continues to a WCM diagnostic data manager routine 1100, at block 1014. If the request is not for the diagnostic data, routine 1000 continues to the error handling routine, at block 1010.

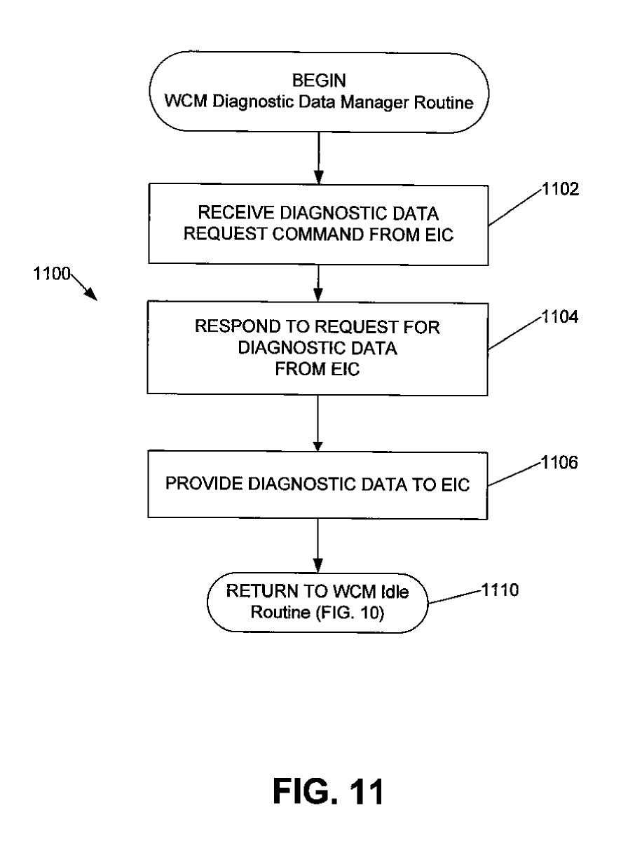

FIG. 11 is an example flow diagram of the WCM diagnostic data manager routine 1100. At block 1102, the wireless communication module 224 receives a diagnostic data request command from the Ethernet interface controller 222. The wireless communication module 224 responds to the request for diagnostic data from the Ethernet interface controller 222, at block 1104. Then the wireless communication module 224 provides the diagnostic data to the Ethernet interface controller 222, at block 1106. The routine 1100 continues and returns to the WCM idle routine 1000, in block 1110.

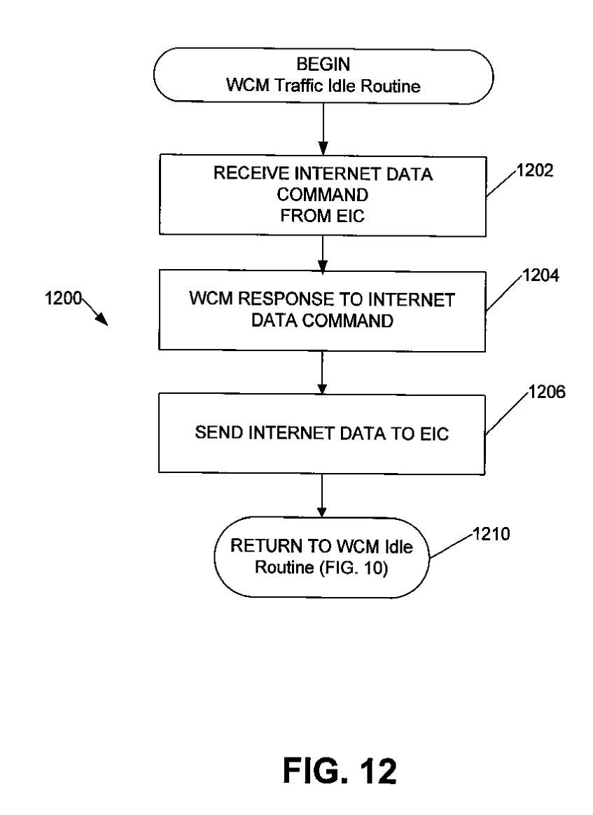

FIG. 12 is an example flow diagram of the WCM traffic idle routine 1200. At block 1202, the wireless communication module 224 receives an Internet data command from the Ethernet interface controller 222. The wireless communication module 224 responds to the Internet data command, in block 1204. Then the wireless communication module 224 sends the Internet data to the Ethernet interface controller 222, at block 1206. The routine 1200 continues and returns to the WCM idle routine 1000, at block 1210.

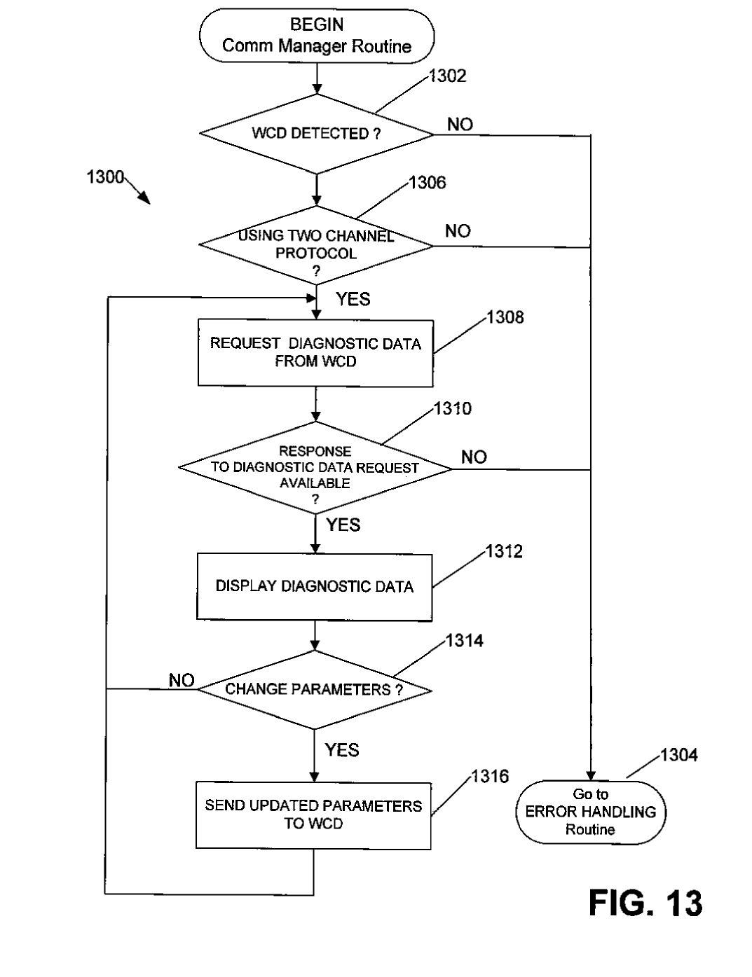

FIG. 13 is an example flow diagram 1300 of a technique for monitoring and controlling the wireless communication device (WCD) 120. At block 1302, a communication manager, for example in an external computing device, determines if the WCD 120 is detected. If no WCD 120 is detected, flow continues to the error handling routine, at block 1304. If a WCD 120 is detected, then it is determined, at block 1306, if it is using a two-channel protocol. If it is not using a two-channel protocol, flow continues to the error handling routine of block 1304. If the WCD 120 is using a two-channel protocol, then diagnostic data is requested from the WCD 120, at block 1308. It is then determined if there is a response to the diagnostic data request available, at block 1310. If there is no response available, flow continues to the error handling routine of block 1304.

If (in block 1310) it is determined that there is a response available, then it is received and the diagnostic data is displayed, at block 1312. It is then determined, at block 1314, if it is desired to change any of the parameters of the WCD 120. If none of the parameters are to be changed, then the flow returns to block 1308. If at least one of the parameters in the WCD 120 are to be changed, then updated parameters are sent to the WCD 120, at block 1316. The flow then continues to 1308.

It should be noted that error handling routines mentioned above can be configured as standard error handling routines that notify the user of the error and appropriately manage the subsequent flow of the parent routine as a result of the error. However, in some implementations, special error handling routines can be generated to handle the generated error.

Various implementations of the invention are realized in electronic hardware, computer software, or combinations of these technologies. Some implementations include one or more computer programs executed by a computing device. For example, in one implementation, the method for monitoring and/or converting the status, running diagnostics, and otherwise providing functions related to status and management of the wireless communication device includes one or more computers executing software implementing the monitoring and management functions. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description describes specific examples for monitoring, selecting, and/or converting the status, running diagnostics, and otherwise providing functions related to status and management of the cellular communication device using the Ethernet interface controller, the monitoring and management functions can be provided using other interface controllers similar to the Ethernet Controller.

Accordingly, the present invention is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the implementations disclosed herein can be implemented or performed with a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Thus, it is to be understood that the description and drawings presented herein represent example implementations of the invention and are therefore representative of the subject matter which is broadly contemplated by the present invention. It is further understood that the scope of the present invention fully encompasses other implementations and that the scope of the present invention is accordingly limited by nothing other than the appended claims.

What is claimed is:

1. A method for managing a wireless communication device, the method comprising:
receiving Ethernet data from an external device at an Ethernet interface of the wireless communication device, wherein the data includes network data and diagnostic data;
assigning a first USB channel to the network data and a second USB channel to the diagnostic data;
communicating the first and second USB channels to a wireless communication module;
receiving two channels of USB data from the wireless communication module, wherein USB data assigned to a first channel is network data and data assigned to a second channel is diagnostic data; and
communicating the network data and diagnostic data to the Ethernet interface as Ethernet data.

2. The method of claim 1, wherein the diagnostic data comprises status data.

3. The method of claim 1, wherein the diagnostic data comprises control data.

4. The method of claim 1, wherein the network data comprises Internet data.

5. The method of claim 1, wherein communicating Ethernet data comprises wireless communication.

6. The method of claim 5, wherein communicating wirelessly comprises a Wi-Fi interface.

7. The method of claim 1, wherein communicating Ethernet data comprises wired communication.

8. The method of claim 1, wherein the first and second USB channels corresponds to first and second USB addresses.

9. A wireless communication device comprising:
an Ethernet port configured to transmit and receive Ethernet data with external devices;
an Ethernet interface controller module in communication with the Ethernet port; and
a wireless communication module in communication with the Ethernet interface controller module and in communication with a wireless network,
wherein communication between the Ethernet interface controller and the Ethernet port comprises Ethernet communication that includes management data and network data,
wherein communication between the Ethernet interface controller module and the wireless communication module comprises USB communication, and
wherein the management data is assigned to a first USB channel and the network data is assigned to a second USB channel.

10. The wireless communication device of claim 9, wherein the wireless communication device is a communication terminal.

11. The wireless communication device of claim 9, wherein the management data comprises
data for accessing status about the communication module.

12. The wireless communication device of claim 9, wherein the management data comprises
data for accessing security control features of the wireless communication module.

13. The wireless communication device of claim 9, wherein the management data comprises
data for modifying service parameters of the wireless communication module.

14. The wireless communication device of claim 9, wherein the management data comprises
data for upgrading software of the wireless communication module.

15. The wireless communication device of claim 9, wherein the management data comprises
system test data.

16. The wireless communication device of claim 91 wherein the wireless network comprises a cellular network.

17. The wireless communication device of claim 9, wherein the wireless network comprises a CDMA network.

18. The wireless communication device of claim 9, wherein the wireless network comprises a GSM network.

19. The wireless communication device of claim 9, wherein the network data comprises Internet data.

20. The wireless communication device of claim 9, wherein the communication with the wireless network further comprises
communication with the Internet.

21. The wireless communication device of claim 9, wherein the first and second USB channels correspond to first and second USB addresses, respectively.

22. A wireless communication device comprising:
means for receiving Ethernet data from an external device, wherein the data includes network data and diagnostic data;
means for assigning a first USB channel to the network data and a second USB channel to the diagnostic data;
means for communicating the first and second USB channels to a wireless communication module;
means for receiving two channels of USB data from the wireless communication module, wherein USB data assigned to the first channel is network data and data assigned to the second channel is diagnostic data; and
means for communicating the network data and diagnostic data to the Ethernet interface as Ethernet data.
